(19) United States
(12) Patent Application Publication
(10) Pub. No.: US 2022/0417633 A1
(43) Pub. Date: Dec. 29, 2022

(54) SINGLE SHRAPNEL BONE CONDUCTION OSCILLATOR

(71) Applicant: DONGGUAN WANTAI ELECTRONICS TECHNOLOGY CO., LTD., DONGGUAN (CN)

(72) Inventors: CONGDONG SHA, DONGGUAN (CN); ZHIGANG WANG, DONGGUAN (CN); SHICHUN ZHAO, DONGGUAN (CN); YUANYUAN SHE, DONGGUAN (CN); FENG ZHANG, DONGGUAN (CN)

(21) Appl. No.: 17/671,418

(22) Filed: Feb. 14, 2022

(30) Foreign Application Priority Data
Jun. 29, 2021 (CN) 2021214591411

(51) Int. Cl. H04R 1/10; H04R 9/02

(52) U.S. Cl. CPC H04R 1/10; H04R 9/025; H04R 2460/13

(57) ABSTRACT

The invention disclose a single-shrapnel bone conduction oscillator, comprising an embedded shrapnel-type bracket, a first combined bracket being snap-connected to a middle of a top of the embedded shrapnel-type bracket, and a second combined bracket being snap-connected an inside of the embedded shrapnel-type bracket, a voice coil being sleeved on an outer surface of the second combined bracket, a washer being placed inside the voice coil, a magnet being placed on a bottom portion of the washer, and a U-CUP being snap-connected to an bottom portion of the embedded shrapnel-type bracket. The invention has a simple structure. The invention adopts the single-shrapnel type design provided, when the oscillator adds an electric signal, the first combined bracket is fixed with the front shell of the headset to generate vibration, and the magnetic circuit is fixed in the embedded shrapnel bracket. The front shell of the headset generates reverse vibration, which cancels the sound produced by the vibration of the main body. Thereby solve the problem of sound leakage after the bone conduction oscillator is installed as an earphone. Thus, the sound leakage defect of the headset is perfectly improved, the quality of the headset is improved, and the user's experience is enhanced.

### FIELD OF THE INVENTION

The invention relates to the technical field of bone conduction oscillators, specifically to a single-shrapnel bone conduction oscillator.

### BACKGROUND OF THE INVENTION

Bone conduction is a method of sound conduction, which converts sound into mechanical vibrations of different frequencies, and transmits sound waves through the human skull, bone labyrinth, inner ear lymph, auger, auditory nerve, and auditory center. Compared with the classic sound conduction method that generates sound waves through the diaphragm, bone conduction eliminates many steps of sound wave transmission, and can achieve clear sound restoration in noisy environments and sound waves will not affect others because of the diffusion in the air. The bone conduction oscillator headset is a new type of electro-acoustic conversion device developed based on the sound conduction method of bone conduction. In the existing bone conduction technology, due to the problem of sound leakage in the structural design of the bone conduction oscillator, the quality of the headset is reduced, the user's experience is reduced, and the practicability is poor.

### SUMMARY OF THE INVENTION

The purpose of this invention is to provide a single-shrapnel bone conduction oscillator to solve the problems raised in the above-mentioned background art.

In order to achieve the above-mentioned purpose, this invention provides the following technical solutions:

a single-shrapnel bone conduction oscillator, comprising: an embedded shrapnel-type bracket, a first combined bracket being snap-connected to a middle of a top of the embedded shrapnel-type bracket, and a second combined bracket being snap-connected an inside of the embedded shrapnel-type bracket, a voice coil being sleeved on an outer surface of the second combined bracket, a washer being placed inside the voice coil, a magnet being placed on a bottom portion of the washer, and a U-CUP being snap-connected to an bottom portion of the embedded shrapnel-type bracket. The invention has a simple structure. The invention adopts the single-shrapnel type design provided, when the oscillator adds an electric signal, the first combined bracket is fixed with the front shell of the headset to generate vibration, and the magnetic circuit is fixed in the embedded shrapnel bracket. The front shell of the headset generates reverse vibration, which cancels the sound produced by the vibration of the main body. Thereby solve the problem of sound leakage after the bone conduction oscillator is installed as an earphone. Thus, the sound leakage defect of the headset is perfectly improved, the quality of the headset is improved, and the user's experience is enhanced.

As a preferred technical solution of the invention, the shapes of the embedded shrapnel-type bracket and the first combined bracket are both ellipse, and a through hole is formed in the middle of the top of the embedded shrapnel-type bracket, and the first combined bracket match with the through hole.

As a preferred technical solution of the invention, a groove is formed inside the embedded shrapnel-type bracket, a bump is fixedly installed on a top of the second combined bracket, and the bump on the top of the second combined bracket matches the groove on the inside of the embedded shrapnel-type bracket.

As a preferred technical solution of the invention, the shapes of the voice coil, the second combined bracket, the washer and the magnet are ellipse, and the size of the second combined bracket, the size of the washer and the size of the magnet all match the size of the voice coil.

As a preferred technical solution of the invention, the shape of the U-CUP is ellipse, and a surface of the bottom portion of the embedded shrapnel-type bracket is opened with an ellipse groove, and the ellipse groove matches the U-CUP.

Compared with the prior art, the beneficial effects of the invention are: the invention has a simple structure through the single-shrapnel-type design of the embedded shrapnel-type bracket, when the oscillator adds an electric signal, the first combined bracket is fixed with the front shell of the headset to generate vibration, and the magnetic circuit is fixed in the embedded shrapnel bracket. The front shell of the headset generates reverse vibration, which cancels the sound produced by the vibration of the main body. Thereby solve the problem of sound leakage after the bone conduction oscillator is installed as an earphone. Thus, the sound leakage defect of the headset is perfectly improved, the quality of the headset is improved, and the user's experience is enhanced.

### BRIEF DESCRIPTIONS OF THE DRAWINGS

FIG. 1 is an exploded diagram of an overall structure of the invention; and

FIG. 2 is a side view of an overall structure of the invention.

In the drawings: 1 is embedded shrapnel-type bracket; 2 is first combined bracket; 3 is second combined bracket; 4 is voice coil; 5 is washer; 6 is magnet; 7 is U-CUP.

### DETAILED DESCRIPTION

The technical solutions in the embodiments of the invention will be clearly and completely described below with reference to the accompanying drawings in the embodiments of the invention. Obviously, the described embodiments are only a part of the embodiments of the invention, rather than all the embodiments. Based on the embodiments in the invention, all other embodiments obtained by those of ordinary skill in the art without creative work, they fall within the protection scope of the invention.

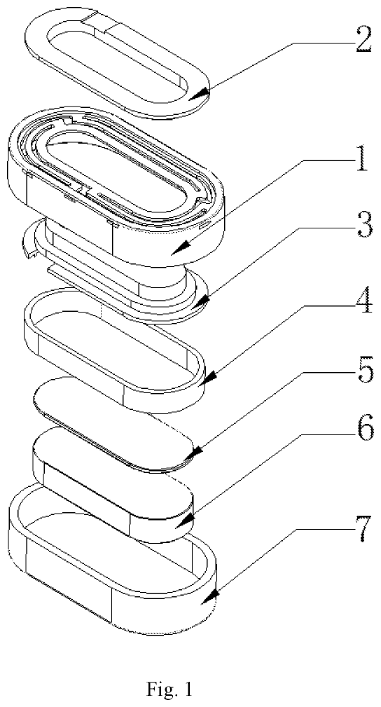

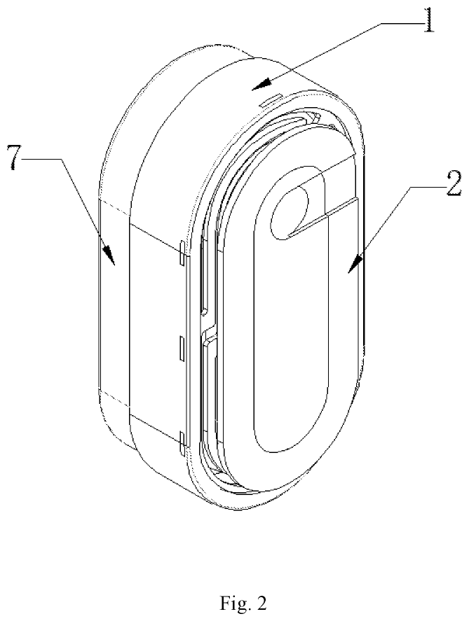

As shown in FIGS. 1 and 2, the invention disclose a single-shrapnel bone conduction oscillator, comprising: an embedded shrapnel-type bracket 1, a first combined bracket 2 being snap-connected to a middle of a top of the embedded shrapnel-type bracket 1, and a second combined bracket 3 being snap-connected an inside of the embedded shrapnel-type bracket 1, a voice coil 4 being sleeved on an outer surface of the second combined bracket 3, a washer 5 being placed inside the voice coil 4, a magnet 6 being placed on a bottom portion of the washer 5, and a U-CUP 7 being snap-connected to an bottom portion of the embedded shrapnel-type bracket 1.

Preferably, the shapes of the embedded shrapnel-type bracket 1 and the first combined bracket 2 are both ellipse, and a through hole is formed in the middle of the top of the embedded shrapnel-type bracket 1, and the first combined bracket 2 and the through hole to match. Therefore, it is convenient to install the first combined bracket 2 in the middle of the top of the embedded shrapnel-type bracket 1.

Preferably, a groove is formed inside the embedded shrapnel-type bracket 1, a bump is fixedly installed on a top of the second combined bracket 3, and the bump on the top of the second combined bracket 3 matches the groove on the inside of the embedded shrapnel-type bracket 1. Therefore, it is convenient to install the second combined bracket 3 in the groove inside the embedded shrapnel-type bracket 1 through the snap-fit of the bump.

Preferably, the shapes of the voice coil 4, the second combined bracket 3, the washer 5 and the magnet 6 are ellipse, and the size of the second combined bracket 3, the size of the washer 5 and the size of the magnet 6 all match the size of the voice coil 4. Therefore, it is convenient to sleeve the voice coil 4 on the outside of the second combined bracket 3, and then place the washer 5 and the magnet 6 inside the voice coil 4.

Preferably, the shape of the U-CUP 7 is ellipse, and a surface of the bottom portion of the embedded shrapnel-type bracket 1 is opened with an ellipse groove, and the ellipse groove matches the U-CUP 7. It is convenient to snap-fit the U-CUP 7 into the ellipse groove of the bottom portion of the embedded shrapnel-type bracket 1.

In specific use, install the first combined bracket 2 in the middle of the top of the embedded shrapnel-type bracket 1, and by snap-fitting the bump on the top of the second combined bracket 3 into the groove inside the embedded shrapnel-type bracket 1, sleeve the voice coil 4 on the outside of the second combined bracket 3, then place the washer 5 and the magnet 6 inside the voice coil 4 in turn, and snap and install the U-CUP 7 in the ellipse groove on the surface of the embedded shrapnel-type bracket 1 bottom portion. The invention has a simple structure through the single-shrapnel-type design of the embedded shrapnel-type bracket 1, when the oscillator adds an electric signal, the first combined bracket 2 is fixed with the front shell of the headset to generate vibration, and the magnetic circuit is fixed in the embedded shrapnel bracket. The front shell of the headset generates reverse vibration, which cancels the sound produced by the vibration of the main body. Thereby solve the problem of sound leakage after the bone conduction oscillator is installed as an earphone. Thus, the sound leakage defect of the headset is perfectly improved, the quality of the headset is improved, and the user's experience is enhanced.

Although the invention has been described in detail with reference to the foregoing embodiments, those skilled in the art can still modify the technical solutions described in the foregoing embodiments, or perform equivalent replacements for some of the technical features. Any modification, equivalent replacement, improvement, etc. made within the spirit and principles of this invention shall be included in the protection scope of this invention.

What is claimed is:

1. A single-shrapnel bone conduction oscillator, comprising:
an embedded shrapnel-type bracket (1), a first combined bracket (2) being snap-connected to a middle of a top of the embedded shrapnel-type bracket (1), and a second combined bracket (3) being snap-connected an inside of the embedded shrapnel-type bracket (1), a voice coil (4) being sleeved on an outer surface of the second combined bracket (3), a washer (5) being placed inside the voice coil (4), a magnet (6) being placed on a bottom portion of the washer (5), and a U-CUP (7) being snap-connected to a bottom portion of the embedded shrapnel-type bracket (1).

2. A single-shrapnel bone conduction oscillator according to claim 1, wherein:
the shapes of the embedded shrapnel-type bracket (1) and the first combined bracket (2) are both ellipse, and a through hole is formed in the middle of the top of the embedded shrapnel-type bracket (1), and the first combined bracket (2) match with the through hole to.

3. A single-shrapnel bone conduction oscillator according to claim 1, wherein:
a groove is formed inside the embedded shrapnel-type bracket (1), a bump is fixedly installed on a top of the second combined bracket (3), and the bump on the top of the second combined bracket (3) matches the groove on the inside of the embedded shrapnel-type bracket (1).

4. A single-shrapnel bone conduction oscillator according to claim 1, wherein:
the shapes of the voice coil (4), the second combined bracket (3), the washer (5) and the magnet (6) are ellipse, and the size of the second combined bracket (3), the size of the washer (5) and the size of the magnet (6) all match the size of the voice coil (4).

5. A single-shrapnel bone conduction oscillator according to claim 1, wherein:
the shape of the U-CUP (7) is ellipse, and a surface of the bottom portion of the embedded shrapnel-type bracket (1) is opened with an ellipse groove, and the ellipse groove matches the U-CUP (7).
